(19) United States
(12) Patent Application Publication
(10) Pub. No.: US 2026/0143539 A1
(43) Pub. Date: May 21, 2026

(54) METHOD OF WIRELESS COMMUNICATION AND RELATED DEVICES

(71) Applicant: INNOPEAK TECHNOLOGY, INC., Palo Alto, CA (US)

(72) Inventor: Marcus Wong, Palo Alto, CA (US)

(73) Assignee: INNOPEAK TECHNOLOGY, INC., Palo Alto, CA (US)

(21) Appl. No.: 19/123,283

(22) PCT Filed: Oct. 24, 2023
(86) PCT No.: PCT/US2023/035793

§ 371 Date: Apr. 22, 2025

Related U.S. Application Data
(60) Provisional application No. 63/419,266, filed on Oct. 25, 2022.

(51) Int. Cl. H04W 76/14; H04W 88/04

(52) U.S. Cl. CPC H04W 76/14; H04W 88/04

(57) ABSTRACT

A wireless communication method 100 are related devices are proposed. In the method, a first user equipment (UE) performs a first security procedure to establish a first secure communication with a UE-to-UE relay node for communication with a second UE, sends a direct communication request to the second UE via the UE-to-UE relay node, performs direct security operation to establish a second secure communication between the first UE and the second UE, and disables the first secure communication with the UE-to-UE relay node during or after the second secure communication with the second UE is established. Since only one security policy is applied, this enables the UEs and the UE-to-UE relay node to more efficiently manage the use of their resources.

### CROSS-REFERENCE TO RELATED APPLICATIONS

This application claims the benefit of priority to U.S. Provisional Application No. 63/419,266, filed on Oct. 25, 2022, which is incorporated by reference herein in its entirety.

### TECHNICAL FIELD

The present application relates to wireless communication, and more particularly, to a method of wireless communication and related devices.

### BACKGROUND ART

Communication systems and networks have developed towards being a broadband and mobile system. For cellular wireless communication systems, the Third Generation Partnership Project (3GPP) has developed the so-called Long Term Evolution (LTE) system, namely, an Evolved Universal Mobile Telecommunication System Territorial Radio Access Network (E-UTRAN). Evolved from LTE, the so-called 5G or New Radio (NR) systems where one or more cells are supported by a base station known as a gNB. In 5G NR, a user equipment (UE) is connected by a wireless link to a radio access network (RAN). The RAN includes a set of base stations (BSs) which provide wireless links to the UEs located in cells covered by the base station, and an interface to a core network (CN) which provides overall network control. The RAN and CN each conduct respective functions in relation to the overall network.

In 5G Proximity Service, two user equipment devices that are out of network coverage can be connected by a UE-to-UE relay (also referred to herein as a “UE-to-UE relay node”). Each UE may establish secure sidelink (or PC5) connectivity individually with the UE-to-UE relay before the UEs can establish secure connectivity with each other via the UE-to-UE relay. Secure connectivity usually means having security turned on (e.g., confidentiality-protection, integrity-protection, or replay-protection) over the communication link between the two entities (e.g., UEs).

Secure communication between two entities, e.g., such as UEs, may be facilitated in various ways using a 4G or 5G cellular network. For example, the UEs can communicate with each other using an upper layer application, e.g., such as a Facebook™ or a WhatsApp™, that uses end-to-end encryption on the application layer. Here, the UEs also connect to the cellular network using lower layer security at the Packet Data Convergence Protocol (PDCP) layer, which facilitates encryption between UE and a base station. FIG. 1 is provided to illustrate UE-to-UE communication protected at different layers. As depicted in FIG. 1, Link #1 and Link #2 are protected at lower layer (e.g., PDCP layer) between the UEs and the network, and Link #3 is protected at higher layer (e.g., application layer) between UE #1 and UE #2. In addition, Link #4 can be protected at either application or transport layer.

However, neither the UE nor the network is aware that the UE's communication with the other UE using the higher layer application. This means that there is encryption between the two UEs via the upper layer application and for each UE individually with the network via the lower layer security. Since there is no negotiation between the security applied to the different layers at either the network side or the UE side, the communication between the UE and the other UE and between the UEs and the UE-to-UE relay is then double-protected.

Since the double protection (e.g., double encryption) takes place at different layers and in different security domains, and because each layer is unaware of what is happening at the other layers, the double protection is unavoidable. Moreover, network nodes are not power-constrained when compared to a UE-to-UE relay node. Consequently, an efficient use of resources such as power to provide the additional (e.g., unnecessary) security is not a prior concern in existing systems. On the other hand, UE-to-UE relay nodes (by definition a UE-to-UE relay node provides connectivity service to two or more UEs that may be outside of network coverage area to communicate with each other) and UEs (which may be outside of network coverage area) are power-constrained and should manage the use of their resources more efficiently.

### SUMMARY

In a first aspect, some embodiments of the present application provide a method of wireless communication of a first user equipment (UE), including: performing, by at least one processor, a first security procedure to establish a first secure communication with a UE-to-UE relay node for communication with a second UE; sending, by a communication interface, a direct communication request to the second UE via the UE-to-UE relay node; performing, by the at least one processor, direct security operation to establish a second secure communication between the first UE and the second UE; and disabling, by the at least one processor, the first secure communication with the UE-to-UE relay node during or after the second secure communication with the second UE is established.

In a second aspect, some embodiments of the present application provide a first user equipment (UE), including: at least one processor, configured to perform a first security procedure to establish a first secure communication with a UE-to-UE relay node for communication with a second UE; and a communication interface, coupled to the at least one processor, configured to send a direct communication request to the second UE via the UE-to-UE relay node, wherein the at least one processor is further configured to: perform direct security operation to establish a second secure communication between the first UE and the second UE; and disable the first secure communication with the UE-to-UE relay node during or after the second secure communication with the second UE is established.

In a third aspect, some embodiments of the present application provide a method of wireless communication of a first user equipment (UE), including: determining, by at least one processor, that hop-by-hop security will be used for communication with a second UE via a UE-to-UE relay node; performing, by the at least one processor, a hop-by-hop security procedure to establish a first secure communication with the UE-to-UE relay node for communication with the second UE; sending, by a communication interface, a direct communication request to the second UE via the UE-to-UE relay node; receiving, by the communication interface, a direct communication response from the second UE via the UE-to-UE relay node; and communicating, by the communication interface, with the second UE via the UE-to-UE relay node using the hop-by-hop security.

In a fourth aspect, some embodiments of the present application provide a first user equipment (UE), including at least one processor and a communication interface coupled to the at least one processor, wherein the at least one processor and a communication interface are configured to cooperate with each other to execute the method described above.

### DESCRIPTION OF DRAWINGS

In order to more clearly illustrate the embodiments of the present application or related art, the following figures that will be described in the embodiments are briefly introduced. It is obvious that the drawings are merely some embodiments of the present application, a person having ordinary skill in this field can obtain other figures according to these figures without paying the premise.

FIG. 1 is a schematic diagram illustrating UE-to-UE communication protected at different layers.

FIG. 2 is a block diagram illustrating a communication system including a relay.

FIG. 3 is a block diagram illustrating a possible relay architecture to which the present application is applicable.

FIG. 4 is a schematic diagram illustrating a use of hop-by-hop protection for UE-to-UE communication according to some embodiments of the present application.

FIG. 5 is a schematic diagram illustrating a use of end-to-end protection for UE-to-UE communication according to some embodiments of the present application.

FIG. 6 is a flowchart of a method of wireless communication according to a first embodiment of the present application.

FIG. 7 is a schematic diagram illustrating a call flow for end-to-end secure communication according to some embodiments of the present application.

FIG. 8 is a flowchart of a method of wireless communication according to a second embodiment of the present application.

FIG. 9 is a schematic diagram illustrating a call flow for hop-by-hop secure communication according to some embodiments of the present application.

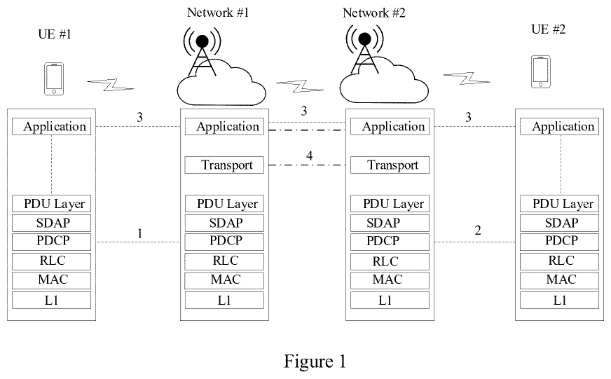

### DETAILED DESCRIPTION OF EMBODIMENTS

Embodiments of the disclosure are described in detail with the technical matters, structural features, achieved objects, and effects with reference to the accompanying drawings as follows. Specifically, the terminologies in the embodiments of the present application are merely for describing the purpose of the certain embodiment, but not to limit the disclosure.

In this document, a combination such as “at least one of A, B, or C,” “one or more of A, B, or C,” “at least one of A, B, and C,” “one or more of A, B, and C,” or “A, B, and/or C” may be A only, B only, C only, A and B, A and C, B and C, or A and B and C, where any combination may contain one or more members of A, B, or C.

In 5G Proximity Service for example, two UEs out of network coverage can be connected by a UE-to-UE relay. Each UE and UE-to-UE relay will need to establish secure sidelink (or PC5) connectivity individually before the UEs can establish secure connectivity with each other via the UE-to-UE relay. Secure connectivity usually means having security turned on (e.g., confidentiality-, integrity-, or replay-protection) over the communication link between the two entities (e.g., UEs or between UE and UE-to-UE relay) that are communicating.

Once each UE established secure connection with the UE-to-UE relay and both UEs established secure connection with each other via the UE-to-UE relay, having security turned on for both UEs to the relay links and the UE-to-UE link (e.g., double-encryption) is wasteful and inefficient to UEs' and relay's resources. UE and UE-to-UE relay resources are important considerations, especially considering many deployment scenarios of the UE-to-UE relay communications are in disaster-stricken areas where resources (e.g., network, power, etc.) are limited for extensive period of time.

The present application provides a mechanism to facilitate secure communication between two UEs via a UE-to-UE relay efficiently by negotiation among the UEs and the UE-to-UE relay to have security only on the UE-to-relay links (e.g., hop-by-hop) or on the UE-to-UE links (e.g., end-to-end).

Consequently, the present application enables the UEs and UE-to-UE relay node to more efficiently manage the use of their resources while providing (and maintaining) the security of communication between two UEs communicating via a UE-to-UE relay.

Further details of the application are provided below.

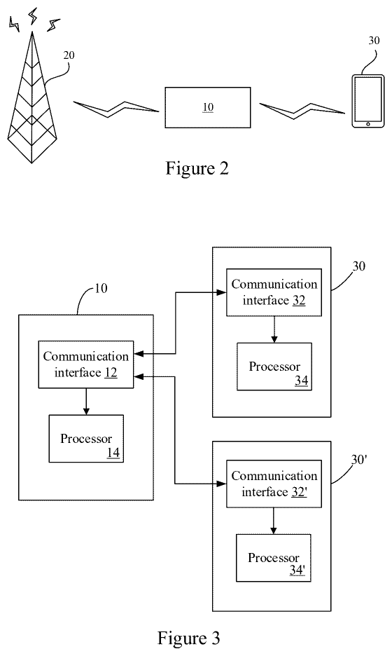

FIG. 2 is a block diagram illustrating a communication system including a relay (e.g., UE-to-UE relay or UE-to-Network relay). The communication system includes a relay 10, a base station (e.g., gNB) 20 and at least one user equipment 30. The relay 10 communicates with the base station 20 and the at least one user equipment 30. The relay 10 serves as an intermediary device that facilitates the transmission of signals in downlink and uplink directions between the base station and the user equipment(s), especially in scenarios where direct communication is challenging. A user equipment with relay capability can be taken as the relay 10. The relay 10 may enhance coverage, capacity, reliability and energy efficiency while being cost-effective and flexible for various deployment scenarios.

FIG. 3 is a block diagram illustrating a possible relay architecture to which the present application is applicable. The relay 10 would be a UE-to-UE relay, which can facilitate communication between two UEs 30, 30′ even though a base station is not available and may establish secure connectivity for the two UEs 30, 30′. The UE-to-UE relay 10 and the two UEs 30, 30′ can execute embodiments of the method according to the present application. The UE-to-UE relay 10 and the two UEs 30, 30′ each include a communication interface 12, 32 or 32′ and a processor 14, 34 or 34′, which are electrically connected with each other. The communication interfaces 12, 32, 32′ are used for transmitting and/or receiving signals. The processors 14, 34, 34′ are used for processing signals, and any other control flow or doing some computations. The processors 14, 34, 34′ and the communication interfaces 12, 32, 32′ may be configured to implement proposed functions, procedures and/or methods described in this description. Layers of radio interface protocols may be implemented in the processors 14, 34, 34′. The UE-to-UE relay 10 and the two UEs 30, 30′ may each include a memory operatively storing a variety of program and information to operate a connected processor. Each of the communication interfaces 12, 32, 32′ is operatively coupled with a connected processor, transmits and/or receives radio signals.

Each of the processors 14, 34, 34′ may include a general-purpose central processing unit (CPU), an application-specific integrated circuits (ASICs), other chipsets, logic circuits and/or data processing devices. The memory may include a read-only memory (ROM), a random access memory (RAM), a flash memory, a memory card, a storage medium, other storage devices, and/or any combination of the memory and storage devices. Each of the communication interfaces 12, 32, 32′ may include baseband circuitry and radio frequency (RF) circuitry to process radio frequency signals. When the embodiments are implemented in software, the techniques described herein can be implemented with modules, procedures, functions, entities and so on, that perform the functions described herein. The modules can be stored in a memory and executed by the processors. The memory can be implemented within a processor or external to the processor, in which those can be communicatively coupled to the processor via various means are known in the art.

The present application may provide secure relay service in a 5G communication system for example when the two communicating UEs are out of network coverage.

When UEs are outside of network coverage, they can communicate with each other either directly using side link or indirectly via a relay. When the UEs are communicating via a UE-to-UE relay, the present application enables secure communication between two UEs connected via a UE-to-UE relay by either end-to-end or by hop-by-hop.

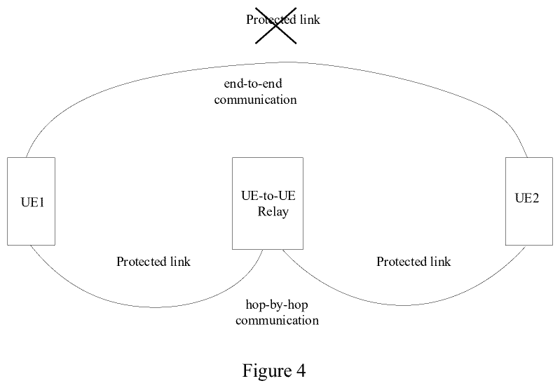

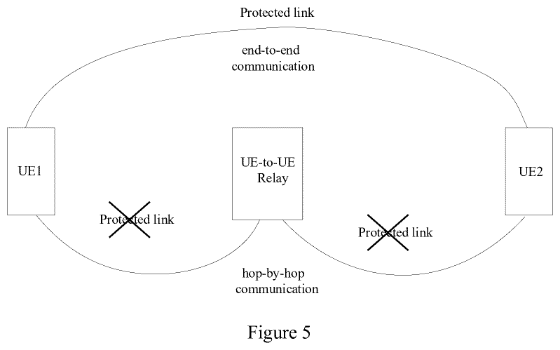

FIG. 4 is a schematic diagram illustrating a use of hop-by-hop protection for UE-to-UE communication according to some embodiments of the present application. FIG. 5 is a schematic diagram illustrating a use of end-to-end protection for UE-to-UE communication according to some embodiments of the present application. As depicted in FIG. 4 and FIG. 5, secure communication may be achieved by either hop-by-hop or end-to-end security applied over the communication link. For the hop-by-hop security depicted in FIG. 4, a first protected link is established between UE1 and the UE-to-UE replay, and a second protected link is established between UE2 and the UE-to-UE replay. For the end-to-end security depicted in FIG. 5, a protected link is established between UE1 and UE2. Efficiency may be achieved by not applying security twice over the same communication links.

In the present application, after UE1 and UE2 establish end-to-end communication, to maintain the same level of security and to achieve a high level of efficiency, either the hop-by-hop security will not be used (or will be turned off) or the end-to-end security will not be used (or will be turned off). That is, the communication between UE1 and UE2 can have security only on the UE-to-relay links (e.g., hop-by-hop) or on the UE-to-UE links (e.g., end-to-end). The link security that will not be used (or will be turned off) can be left up to implementation or based on a negotiation among UE1, UE2, and UE-to-UE relay.

For example, UE1/UE2 and the UE-to-UE relay can be configured with security policy from the operator in which a hop-by-hop security is always used. The UE-to-UE relay may communicate with UEs that the links between UE1 and UE-to-UE relay and between UE2 and the UE-to-UE relay are always protected. Not allowing or disabling or turning off end-to-end security can be communicated to the UE1/UE2 as part of UE-to-UE communication set up or dedicated signaling after UE-to-UE communication is established.

Similarly, if the security policy indicates end-to-end security is always used, hop-by-hop will not be used or will be turned off after end-to-end security is established. The UE-to-UE relay will communicate with UEs that the links between UE1 and the UE-to-UE relay and between UE2 and the UE-to-UE relay will not be protected once the UE-to-UE communication is established. Not allowing or disabling or turning off hop-by-hop security can be communicated to the UEs as part of UE-to-UE communication set up or dedicated signaling after UE-to-UE communication is established.

The security policy received by UE1, UE2, and the UE-to-UE relay can be different or conflicting. For example, UE1's security policy may use hop-by-hop security, while UE2's security policy uses end-to-end security. In case of conflicting security policies between UE1 and UE2, the UE-to-UE relay may decide to use its own security policy. In general, since the UE-to-UE relay is the one providing the relay service, its security policy should supersede that of either of UE1 and UE2. In case UE1 and UE2 are not configured with security policy, the UE-to-UE relay may also decide whether hop-by-hop or end-to-end security is used and communicate this decision to UE1 and UE2 either during or after UE1 and UE2 establishing end-to-end communication.

UE1, UE2 and the UE-to-UE relay may also negotiate among themselves to determine whether hop-by-hop or end-to-end security is to be used once UE1 and UE2 establish communication via the relay. The negotiation can be, e.g., based on capabilities (e.g., security capabilities) or the security policy of one or more of UE1, UE2 and the UE-to-UE relay.

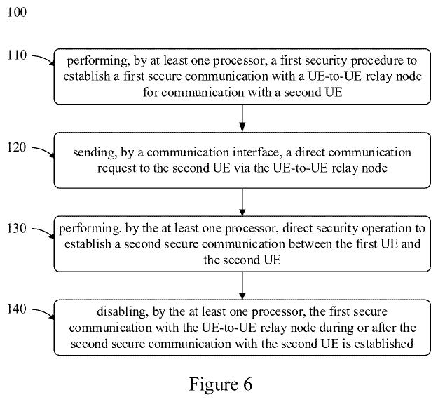

FIG. 6 is a flowchart of a method of wireless communication 100 according to a first embodiment of the present application. The wireless communication method 100 is applied to a first user equipment (denoted as UE1 herein). An exemplary structure of UE1 may be referred to the user equipment 30 depicted in FIG. 3. The wireless communication method 100 may be implemented in the communication interface 32 and the processor 34 of FIG. 3. The method 100 includes the following steps.
Step 110: performing, by at least one processor, a first security procedure to establish a first secure communication with a UE-to-UE relay node for communication with a second UE;

In this step, the first UE establishes a first secure communication (e.g., a secure PC5 connection) with a UE-to-UE relay node. To be more specific, a processor of the first UE performs a first security procedure to establish the first secure communication. Security parameters necessary for establishment of the first secure communication may be used in the first security procedure. Before the first security procedure, UE-to-UE relay node discovery and selection may be performed. In order to communicate with a second UE (denoted as UE2) via the UE-to-UE relay node, the selected relay would be a UE-to-UE relay node that can provide for both the first UE and the second UE better or best communication quality.

The second UE may also perform a security procedure similar to that applied in the first UE to establish a secure communication with the UE-to-UE relay node. That is, secure communication is established between the UE-to-UE relay node and the first UE and between the UE-to-UE relay node and the second UE. In order to set up communication between the first UE and the second UE, some information may need to be negotiated via the links between the UE-to-UE relay node and the first UE and between the UE-to-UE relay node and the second UE.

In some embodiments, the UE-to-UE relay node may negotiate with the first UE and the second UE a security policy (e.g., end-to-end security or hop-by-hop security) to be used in communication between the first UE and the second UE (i.e., end-to-end communication). The determined security policy may be transmitted via the link between the UE-to-UE relay node and the first UE (which is used to carry the first secure communication) and the link between the UE-to-UE relay node between the second UE. In this way, the UE-to-UE relay node, the first UE and the second UE are aware of which security policy is going to be used in the end-to-end communication.

In some embodiments, the UE-to-UE relay node communicates to the first UE and the second UE respectively that a certain security policy (e.g., end-to-end security) is to be used, for example, in case the first UE and the second UE are not configured with security policy. In other embodiments, the first UE and the second UE communicate to the UE-to-UE relay node that a certain security policy (e.g., end-to-end security) is used.

In some embodiments, conflicting security policies occur between the first UE and the second UE or the first UE and the second UE are not configured with security policy. In these cases, the UE-to-UE relay node may decide a security policy for the first UE and the second UE (e.g., by negotiating with the first UE and the second UE, or by using a security policy preset in the UE-to-UE relay node, or by based on certain information).
Step 120: sending, by a communication interface, a direct communication request to the second UE via the UE-to-UE relay node;

In this step, since the links between the UE-to-UE relay node and the first UE and between the UE-to-UE relay node and the second UE have been established, in order to establish an end-to-end communication with the second UE, the first UE sends a direct communication request to the second UE via the UE-to-UE relay node by using the communication interface.

In some embodiments, in case end-to-end security is to be used, the direct communication request may piggyback necessary information for security establishment of an end-to-end secure communication between the first UE and the second UE. The first UE may receive a direct communication accept message transmitted from the second UE, in response to the direct communication request, if the second UE accepts the direct communication with the first UE. The direct communication accept message can also be received by the first UE once the end-to-end secure communication is established between the first UE and the second UE.
Step 130: performing, by the at least one processor, direct security operation to establish a second secure communication between the first UE and the second UE; and

In this step, in case end-to-end security is to be used, the first UE performs direct security operation to establish the end-to-end secure communication (i.e., the second secure communication between the first UE and the second UE) by using the processor. Details about the direct security operation may be referred to related operations specified in current Standard. The direct security operation may include, but is not limited, establishment of security credentials necessary for the two UEs to start the end-to-end secure communication, determination of security algorithm (e.g., cipher algorithm and/or integrity protection algorithm) such as Advanced Encryption Standard (AES) or Rivest-Shamir-Adleman (RSA), and etc.
Step 140: disabling, by the at least one processor, the first secure communication with the UE-to-UE relay node during or after the second secure communication with the second UE is established.

In this step, once the second secure communication (e.g., with end-to-end security) with the second UE is established, the first UE disables or turns off (or prohibits) the first secure communication (e.g., with hop-by-hop security) with the UE-to-UE relay node by using the processor. That is, only one security policy (i.e., end-to-end security) is applied for the secure communication between the first UE and the second UE. Therefore, it facilitates secure communication between the two UEs via the UE-to-UE relay node efficiently.

In some embodiments, not allowing or disabling or turning off the first secure communication (e.g., with hop-by-hop security) can be communicated between the UEs as part of UE-to-UE communication set up. That is, the disabling operation may be performed during UE-to-UE communication set up (i.e., during the second secure communication with the second UE is established). In other embodiments, not allowing or disabling or turning off the first secure communication (e.g., with hop-by-hop security) can be achieved via dedicated signaling after UE-to-UE communication is established. That is, the disabling operation may be performed after UE-to-UE communication is established (i.e., after the second secure communication with the second UE is established). The dedicated signaling is a signaling transmitted after the first UE and the second UE have established communication therebetween.

The present application provides the wireless communication method 100 as described above. In this method, the first UE performs a first security procedure to establish a first secure communication with the UE-to-UE relay node for communication with the second UE, sends a direct communication request to the second UE via the UE-to-UE relay node, performs direct security operation to establish a second secure communication between the first UE and the second UE, and disables the first secure communication with the UE-to-UE relay node during or after the second secure communication with the second UE is established. Since only one security policy (i.e., end-to-end security) is applied for the secure communication between the first UE and the second UE, this method enables the UEs and UE-to-UE relay node to more efficiently manage the use of their resources while providing (and maintaining) the security of communication between two UEs communicating via a UE-to-UE relay node.

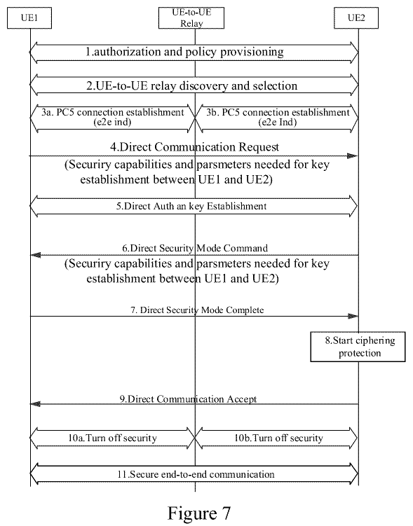

FIG. 7 is a schematic diagram illustrating a call flow for end-to-end secure communication according to some embodiments of the present application. As shown in FIG. 7, the end-to-end secure communication establishment procedure includes the following operations:

Operation 1: authorization and policy information provisioning is performed. In this operation, authorization and policy information (e.g., security parameters, security policies, and other parameters necessary for the two UEs to be able to establish communication) of UE1 may be delivered to UE2 via the network (not shown) or via the UE-to-UE relay, and vice versa. The authorization information may facilitate establishment of communication link. The policy information would be used for UE1 and UE2 to determine security policy (e.g., end-to-end or hop-by-hop).

Operation 2: UE1 and UE2 discover UE-to-UE relay. If there are multiple UE-to-UE relays in the area, UE1 and UE2 select the relay that can provide relay service to them. The selected relay would be a UE-to-UE relay that can provide for both UE1 and UE2 better or best communication quality (e.g., reference signal received power (RSRP) or quality of service (QOS)).

Operations 3a and 3b: UE1 and UE2 establish connection (e.g., PC5 connection) with the UE-to-UE relay respectively. In the process of establishing PC5 connection, either the UE-to-UE relay communicates to UE1 and UE2 respectively that end-to-end security is to be used or UE1 and UE2 communicate to the UE-to-UE relay that end-to-end security is used. In case of conflicting security policies between UE1 and UE2 or UE1 and UE2 are not configured with security policy, the UE-to-UE relay may also decide for UE1 and UE2 which security policy is to be used. In this call flow, end-to-end security is determined by the UE-to-UE relay.

Operations 4-9: UE1 and UE2 establish communication and establish security credentials necessary for the two UEs to start end-to-end secure communication. Security credential establishment procedure may include exchanging of parameters (e.g., UE's security capabilities, Security policy, Nonces, verification codes, etc.) necessary for UE1 and UE2 to establish key materials that can be subsequently used to protect the communication (e.g., end-to-end communication). Specifically, UE1 may transmit a direct communication request, which may piggyback necessary information for the security establishment, to UE2 in operation 4, and UE2 may reply with a direct communication accept message in operation 9 after end-to-end secure communication is established between UE1 and UE2. UE1 and UE2 may perform direct authentication and key establishment in operation 5. Protection algorithm such as Advanced Encryption Standard (AES) or Rivest-Shamir-Adleman (RSA) may be determined in operations 6 and 7. Once the protection algorithm is determined, UE2 can start ciphering protection in operation 8.

Operations 10a and 10b: the UE-to-UE relay disables or turns off security between UE1 and the UE-to-UE relay, and between UE2 and the UE-to-UE relay. It is noted that if hop-by-hop security is also used in addition to end-to-end security, not allowing or disabling or turning off hop-by-hop security can be communicated to the UEs as part of UE-to-UE communication set up or dedicated signaling after UE-to-UE communication is established. It is also noted that turning off hop-by-hop security is seen as more advantageous to conserving the resources of the UE-to-UE relay since hop-by-hop security requires UE-to-UE relay perform both decryption and encryption for every communication exchange between UE1 and UE2 (i.e., UE-to-UE relay decrypts UE1's communication intended for UE2 with security key between UE1 and UE-to-UE relay and then UE-to-UE relay encrypts UE1's communication intended for UE2 with security key between UE-to-UE relay and UE2).

Operation 11: end-to-end secure communication continues between UE1 and UE2 via the UE-to-UE relay.

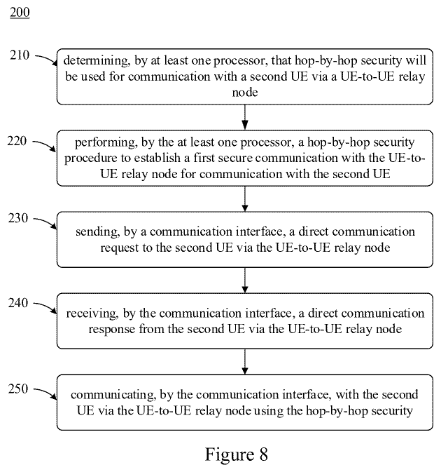

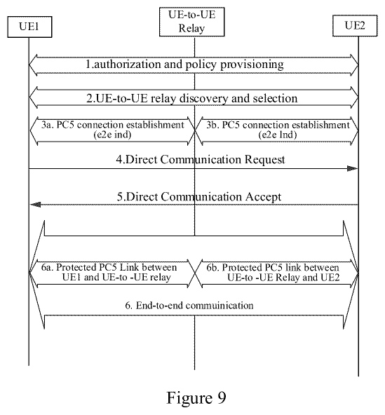

FIG. 8 is a flowchart of a method of wireless communication 200 according to a second embodiment of the present application. The wireless communication method 200 is applied to a first user equipment (denoted as UE1 herein). An exemplary structure of UE1 may be referred to the user equipment 30′ depicted in FIG. 3. The wireless communication method 200 may be implemented in the communication interface 32′ and the processor 34′ of FIG. 3. The method 200 includes the following steps.
Step 210: determining, by at least one processor, that hop-by-hop security will be used for communication with a second UE via a UE-to-UE relay node;

In this step, the first UE determines to use hop-by-hop security by using the processor for communication with a second UE (denoted as UE2) via a UE-to-UE relay node. The hop-by-hop security the first UE determines to use may be a determined security policy by the UE-to-UE relay node by negotiating with the first UE and the second UE or may be a security policy decided by the first UE and agreed by the UE-to-UE relay node.

In some embodiments, the UE-to-UE relay node may negotiate with the first UE and the second UE a security policy (e.g., end-to-end security or hop-by-hop security) to be used in communication between the first UE and the second UE (i.e., end-to-end communication). In this case, the determined security policy is hop-by-hop security, and the determined hop-by-hop security may be transmitted via the link between the UE-to-UE relay node and the first UE and the link between the UE-to-UE relay node between the second UE. In this way, the UE-to-UE relay node, the first UE and the second UE are aware that hop-by-hop security is going to be used in the end-to-end communication.

In some embodiments, the UE-to-UE relay node communicates to the first UE and the second UE respectively that hop-by-hop security is to be used, for example, in case the first UE and the second UE are not configured with security policy. In other embodiments, the first UE and the second UE communicate to the UE-to-UE relay node that hop-by-hop security is used.

In some embodiments, conflicting security policies occur between the first UE and the second UE or the first UE and the second UE are not configured with security policy. In these cases, the UE-to-UE relay node may decide hop-by-hop security as a security policy to be used for the first UE and the second UE (e.g., by negotiating with the first UE and the second UE, or by using a security policy preset in the UE-to-UE relay node (in this case, hop-by-hop security is a preset or default security policy), or by based on certain information).
Step 220: performing, by the at least one processor, a hop-by-hop security procedure to establish a first secure communication with the UE-to-UE relay node for communication with the second UE;

In this step, the first UE establishes a first secure communication (e.g., a secure PC5 connection) with the UE-to-UE relay node. To be more specific, the processor of the first UE performs a hop-by-hop security procedure to establish the first secure communication. Security parameters necessary for establishment of the first secure communication may be used in the hop-by-hop security procedure. Before this procedure, UE-to-UE relay node discovery and selection may be performed. In order to communicate with the second UE via the UE-to-UE relay node, the selected relay would be a UE-to-UE relay node that can provide for both the first UE and the second UE better or best communication quality.

The second UE may also perform a hop-by-hop security procedure similar to that applied in the first UE to establish a secure communication with the UE-to-UE relay node. That is, secure communication is established between the UE-to-UE relay node and the first UE and between the UE-to-UE relay node and the second UE. In order to set up UE-to-UE communication, some information may need to be negotiated via the links between the UE-to-UE relay node and the first UE and between the UE-to-UE relay node and the second UE.
Step 230: sending, by a communication interface, a direct communication request to the second UE via the UE-to-UE relay node;

In this step, since the links between the UE-to-UE relay node and the first UE and between the UE-to-UE relay node and the second UE have been established, in order to establish an end-to-end communication with the second UE, the first UE sends a direct communication request to the second UE via the UE-to-UE relay node by using the communication interface.
Step 240: receiving, by the communication interface, a direct communication response from the second UE via the UE-to-UE relay node; and

In this step, the first UE receives a direct communication response transmitted from the second UE via the communication interface. If the direct communication response is “accept”, it means the second UE agrees to establish end-to-end communication with the first UE. If the direct communication response is “not accept”, it means the second UE disagrees to establish end-to-end communication with the first UE.

In some embodiments, the first UE may not need to establish end-to-end secure communication (e.g., with end-to-end security) with the second UE. That is, the first UE communicates with the second UE without end-to-end secure communication. As a result, only one security policy (i.e., hop-by-hop security) is applied for the secure communication between the first UE and the second UE. However, in other embodiments, establishing the end-to-end secure communication with end-to-end security is allowed. Not allowing or disabling or turning off the end-to-end secure communication may be performed in subsequent processes. For example, disabling the end-to-end secure communication may be achieved via dedicated signaling after UE-to-UE communication is established.
Step 250: communicating, by the communication interface, with the second UE via the UE-to-UE relay node using the hop-by-hop security.

In this step, the communication interface of the first UE is used to communicate with the second UE using the hop-by-hop security. Since hop-by-hop security is used, the links between the first UE and the UE-to-UE relay node and the link between the UE-to-UE relay node and the second UE are secure. The end-to-end communication with security between the first UE and the second UE is achieved using the hop-by-hop security. Since only one security policy (i.e., hop-by-hop security) is involved in the end-to-end communication, it facilitates secure communication between the two UEs via the UE-to-UE relay node efficiently.

The present application provides the wireless communication method 200 as described above. In this method, the first UE determines that hop-by-hop security will be used for communication with the second UE via the UE-to-UE relay node, performs a hop-by-hop security procedure to establish a first secure communication with the UE-to-UE relay node for communication with the second UE, sends a direct communication request to the second UE via the UE-to-UE relay node, receives a direct communication response from the second UE via the UE-to-UE relay node, and communicates with the second UE via the UE-to-UE relay node using the hop-by-hop security. Since only one security policy (i.e., hop-by-hop security) is applied for the secure communication between the first UE and the second UE, this method enables the UEs and UE-to-UE relay node to more efficiently manage the use of their resources while providing (and maintaining) the security of communication between two UEs communicating via a UE-to-UE relay node.

FIG. 9 is a schematic diagram illustrating a call flow for hop-by-hop secure communication according to some embodiments of the present application. As shown in FIG. 7, the hop-by-hop secure communication establishment procedure includes the following operations:

Operation 1: authorization and policy information provisioning is performed. In this operation, authorization and policy information (e.g., security parameters, security policies, and other parameters necessary for the two UEs to be able to establish communication) of UE1 may be delivered to UE2 via the network (not shown) or via the UE-to-UE relay, and vice versa. The authorization information may facilitate establishment of communication link. The policy information would be used for UE1 and UE2 to determine security policy (e.g., end-to-end or hop-by-hop).

Operation 2: UE1 and UE2 discover UE-to-UE relay. If there are multiple UE-to-UE relays in the area, UE1 and UE2 select the relay that can provide relay service to them. The selected relay would be a UE-to-UE relay that can provide for both UE1 and UE2 better or best communication quality (e.g., reference signal received power (RSRP) or quality of service (QoS)).

Operations 3a and 3b: UE1 and UE2 establish secure connection (e.g., PC5 connection) with the UE-to-UE relay respectively. In the process of establishing PC5 connection, either the UE-to-UE relay communicate to UE1 and UE2 respectively that hop-by-hop security is to be used or UE1 and UE2 communicate to the UE-to-UE relay that hop-by-hop security is used. In the process of establishing PC5 links, security is established between UE1 and the UE-to-UE relay and between UE2 and the UE-to-UE relay. In case of conflicting security policies between UE1 and UE2 or UE1 and UE2 are not configured with security policy, the UE-to-UE relay may also decide for UE1 and UE2 which security policy is to be used. In this call flow, hop-by-hop security is determined by the UE-to-UE relay.

Operations 4-5: UE1 and UE2 establish communication between them via the UE-to-UE relay. Since UE1 and UE2 are aware that hop-by-hop security is to be used, there is no need to exchange parameters needed to establish security between UE1 and UE2. Specifically, UE1 may transmit a direct communication request to UE2 in operation 4, and UE2 may reply with a direct communication accept message in operation 9 to establish end-to-end communication without security between UE1 and UE2.

Operations 6, 6a, and 6b: UE1 and UE2 starts communicating with each other. Since hop-by-hop security is used, the links between UE1 and the UE-to-UE relay and the link between the UE-to-UE relay and UE2 are secure. In this case, UE1 encrypts the data destined for UE2 by using the security parameters established between UE1 and UE-to-UE relay. UE1 sends encrypted data to the UE-to-UE relay. The UE-to-UE relay decrypts the data received from UE1. The UE-to-UE relay encrypts the data using security parameters established between the UE-to-UE relay and UE2. The UE-to-UE relay sends the encrypted data to UE2 (i.e., relays the encrypted data to UE2). It is noted that if end-to-end security is also used in addition to hop-by-hop security, not allowing or disabling or turning off end-to-end security can be communicated to the UE1/UE2 as part of UE-to-UE communication set up or dedicated signaling after UE-to-UE communication is established.

Since both the security of communications between UEs and efficiencies of UEs and UE-to-UE relay are important, this application provides a mechanism as described above to efficiently and securely to protect the communication between two UEs when the UEs are communicating with each other via a UE-to-UE relay. The mechanism also ensures UEs communicating via a UE-to-UE relay are using the same protection scheme, whether they are end-to-end or hop-by-hop.

Alternative is to use static configuration or a static security policy, for example always using hop-by-hop or end-to-end security. However, the inflexibility of static configuration may mean less efficiency. For example, if UE-to-UE relay and UEs are always configured to use security, UE1 and UE2 can end up in a suboptimal situation where both hop-by-hop AND end-to-end security are used at the same time.

The embodiment of the present application further provides a first user equipment, which includes at least one processor and a communication interface coupled to the at least one processor, wherein the at least one processor and a communication interface are configured to cooperate with each other to execute any of the methods described above. For brevity, details will not be described herein again.

The embodiment of the present application further provides a second user equipment, which includes at least one processor and a communication interface coupled to the at least one processor, wherein the at least one processor and a communication interface are configured to cooperate with each other to execute any of the methods described above. For brevity, details will not be described herein again.

The embodiment of the present application further provides a UE-to-UE relay node, which includes at least one processor and a communication interface coupled to the at least one processor, wherein the at least one processor and a communication interface are configured to cooperate with each other to execute any of the methods described above. For brevity, details will not be described herein again.'

The embodiment of the present application further provides a computer readable storage medium for storing a computer program. The computer readable storage medium enables a computer to execute corresponding processes implemented in each of the methods of the embodiments of the present application. For brevity, details will not be described herein again.

The embodiment of the present application further provides a computer program product including computer program instructions. The computer program product enables a computer to execute corresponding processes implemented in each of the methods of the embodiments of the present application. For brevity, details will not be described herein again.

The embodiment of the present application further provides a computer program. The computer program enables a computer to execute corresponding processes implemented in each of the methods of the embodiments of the present application. For brevity, details will not be described herein again.

Those of skill in the art will appreciate that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Further, those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present invention.'

The methods, sequences and/or algorithms described in connection with the embodiments disclosed herein may be embodied directly in hardware, in a software module executed by a processor, or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such that the processor can read information from, and write information to, the storage medium. In the alternative, the storage medium may be integral to the processor.

It should be understood that any embodiments disclosed herein as being “non-transitory” do not exclude any physical storage medium, but rather exclude only the interpretation that the medium can be construed as a transitory propagating signal.

The elements and components of an embodiment of the invention may be physically, functionally and logically implemented in any suitable way. Indeed, the functionality may be implemented in a single unit, in a plurality of units or as part of other functional units. Although the present invention has been described in connection with some embodiments, it is not intended to be limited to the specific form set forth herein. Rather, the scope of the present invention is limited only by the accompanying claims. Additionally, although a feature may appear to be described in connection with particular embodiments, one skilled in the art would recognize that various features of the described embodiments may be combined in accordance with the invention. In the claims, the term ‘comprising’ does not exclude the presence of other elements or steps.

Furthermore, although individually listed, a plurality of means, elements or method steps may be implemented by, for example, a single unit or processor. Additionally, although individual features may be included in different claims, these may possibly be advantageously combined, and the inclusion in different claims does not imply that a combination of features is not feasible and/or advantageous. Also, the inclusion of a feature in one category of claims does not imply a limitation to this category, but rather indicates that the feature is equally applicable to other claim categories, as appropriate.

Furthermore, the order of features in the claims does not imply any specific order in which the features must be performed and in particular the order of individual steps in a method claim does not imply that the steps must be performed in this order. Rather, the steps may be performed in any suitable order. In addition, singular references do not exclude a plurality. Thus, references to ‘a’, ‘an’, ‘first’, ‘second’, etc. do not preclude a plurality.

Above all, while the preferred embodiments of the present application have been illustrated and described in detail, various modifications and alterations can be made by persons of ordinary skill in the art. The embodiment of the present application is therefore described in an illustrative but not restrictive sense. It is intended that the present application should not be limited to the particular forms as illustrated, and that all modifications and alterations which maintain the spirit and realm of the present application are within the scope as defined in the appended claims.

1. A method of wireless communication of a first user equipment (UE), comprising:
performing, by at least one processor, a first security procedure to establish a first secure communication with a UE-to-UE relay node for communication with a second UE;
sending, by a communication interface, a direct communication request to the second UE via the UE-to-UE relay node;
performing, by the at least one processor, direct security operation to establish a second secure communication between the first UE and the second UE; and
disabling, by the at least one processor, the first secure communication with the UE-to-UE relay node during or after the second secure communication with the second UE is established.

2. The method of claim 1, wherein a determined security policy is transmitted via the first secure communication once the first secure communication is established, and the determined security policy includes end-to-end security.

3. The method of claim 2, wherein the determined security policy is provided in case of conflicting security policies between the first UE and the second UE or the first UE and the second UE are not configured with security policy.

4. The method of claim 1, further comprising:
transmitting, by the communication interface, a security policy that is used by the first UE to the UE-to-UE relay node via the first secure communication.

5. The method of claim 1, wherein the direct communication request piggybacks necessary information for establishing the second secure communication between the first UE and the second UE.

6. The method of claim 1, wherein disabling the first secure communication is communicated between the first UE and the second UE as part of UE-to-UE communication set up.

7. The method of claim 1, wherein disabling the first secure communication is achieved via dedicated signaling after UE-to-UE communication is established.

8. A first user equipment (UE), comprising:
at least one processor, configured to perform a first security procedure to establish a first secure communication with a UE-to-UE relay node for communication with a second UE; and
a communication interface, coupled to the at least one processor, configured to send a direct communication request to the second UE via the UE-to-UE relay node,
wherein the at least one processor is further configured to:
perform direct security operation to establish a second secure communication between the first UE and the second UE; and
disable the first secure communication with the UE-to-UE relay node during or after the second secure communication with the second UE is established.

9. The first UE of claim 8, wherein a determined security policy is transmitted via the first secure communication once the first secure communication is established, and the determined security policy includes end-to-end security.

10. The first UE of claim 9, wherein the determined security policy is provided in case of conflicting security policies between the first UE and the second UE or the first UE and the second UE are not configured with security policy.

11. The first UE of claim 8, wherein the communication interface is further configured to:
transmit a security policy that is used by the first UE to the UE-to-UE relay node via the first secure communication.

12. The first UE of claim 8, wherein the direct communication request piggybacks necessary information for establishing the second secure communication between the first UE and the second UE.

13. The first UE of claim 8, wherein disabling the first secure communication is communicated between the first UE and the second UE as part of UE-to-UE communication set up.

14. The first UE of claim 8, wherein disabling the first secure communication is achieved via dedicated signaling after UE-to-UE communication is established.

15. A method of wireless communication of a first user equipment (UE), comprising:
determining, by at least one processor, that hop-by-hop security will be used for communication with a second UE via a UE-to-UE relay node;
performing, by the at least one processor, a hop-by-hop security procedure to establish a first secure communication with the UE-to-UE relay node for communication with the second UE;
sending, by a communication interface, a direct communication request to the second UE via the UE-to-UE relay node;
receiving, by the communication interface, a direct communication response from the second UE via the UE-to-UE relay node; and
communicating, by the communication interface, with the second UE via the UE-to-UE relay node using the hop-by-hop security.

16. The method of claim 15, wherein the determined hop-by-hop security is transmitted via the first secure communication once the first secure communication is established.

17. The method of claim 16, wherein the determined hop-by-hop security is provided in case of conflicting security policies between the first UE and the second UE or based on a security policy preset in the UE-to-UE relay node.

18. The method of claim 15, wherein the first UE communicates with the second UE without end-to-end secure communication.

19. A first user equipment (UE), comprising at least one processor and a communication interface coupled to the at least one processor, wherein the at least one processor and a communication interface are configured to cooperate with each other to execute the method of claim 1.
